(19) United States
(12) Patent Application Publication
(10) Pub. No.: US 2007/0274266 A1
(43) Pub. Date: Nov. 29, 2007

(54) Method, System And Apparatus To Support Mobile Ip Version 6 Services in Cdma Systems

(76) Inventors: Johnson Oyama, Tokyo (JP); Ryoji Kato, Kanagawa (JP); Johan Rune, Stockholm (SE); Tony Larsson, Stockholm (SE)

Correspondence Address: ERICSSON INC., 6300 LEGACY DRIVE, M/S EVR 1-C-11, PLANO, TX, 75024, US

(21) Appl. No.: 10/595,014

(22) PCT Filed: Jun. 15, 2004
(86) PCT No.: PCT/SE04/00950

§ 371 Date: Apr. 25, 2006

(30) Foreign Application Priority Data
Jun. 18, 2003 (US) 60479156
Jul. 3, 2003 (US) 60484309
Mar. 9, 2004 (US) 60551039

(51) Int. Cl. H04L 29/06

(52) U.S. Cl. 370/335

(57) ABSTRACT

The invention provides authentication and authorization support for MIPv6 in a CDMA framework by transferring MIPv6-related information in an, preferably extended, authentication protocol in an end-to-end procedure between a mobile node in a visited network and the home network of the mobile node over an AAA infrastructure. Preferably, the end-to-end procedure is executed between the mobile node and an AAA server (34) of the home network In the visited network, after lower-layer setup, point-to-point communication is established between the mobile node and an internetworking access server (22). The access server then communicates with the AAA home server for MIPv6 authentication and authorization of the mobile node. A preferred embodiment uses EAP as basis for the extended authentication protocol. EAP extensions are then used for MIPv6 initiation and re-authentication, while CHAP can be beneficial for MIPv6 hand-in.

### TECHNICAL FIELD

The present invention generally relates to mobile communications and in particular to support for Mobile IP version 6 services in CDMA systems.

### BACKGROUND

Mobile IP (MIP) allows a mobile node to change its point of attachment to the Internet with minimal service disruption. MIP in itself does not provide any specific support for mobility across different administrative domains, which limits the applicability of MIP in a large-scale commercial deployment.

The MIP version 6 (MIPv6) protocol [1] allows nodes to move within the Internet topology while maintaining reachability and on-going connections with correspondent nodes. In this context, each mobile node is always identified by its home address, regardless of its current point of attachment to the IPv6 Internet. While situated away from its home network, a mobile node is also associated with a care-of address, which provides information about the mobile node's current location. IPv6 packets addressed to the mobile node's home address are more or less transparently routed to its care-of address (CoA). The MIPv6 protocol enables IPv6 nodes to cache the binding of a mobile node's home address with its care-of address, and then send any packets destined for the mobile node to the care-of address. To this end, the mobile node sends so-called binding updates to its Home Agent (HA) and the correspondent nodes with which it is communicating every time it moves.

MIPv6 capable mobile nodes, such as cellular phones, laptops and other end-user equipment, can thus roam between networks that belong to their home service provider as well as others. Roaming in foreign networks is enabled as a result of the service level and roaming agreements that exist between operators. MIPv6 provides session continuity within a single administrative domain, but depends on the availability of an Authentication, Authorization and Accounting (AAA) infrastructure to provide its services across different administrative domains, i.e. when roaming outside the network administered by the home operator.

Although Mobile IPv6 can be regarded as a complete mobility protocol, more and/or improved mechanisms that facilitate deployment of MIPv6 are still needed in order to enable large-scale deployment. In particular, solutions facilitating use of MIPv6 in CDMA systems, such as CDMA2000, are lacking. Within the 3GPP2 CDMA2000 framework today, Mobile IPv4 Operation and Simple IPv4/IPv6 Operation have been specified [2]. However, there is no corresponding specification for Mobile IPv6 Operation and how 3GPP2 will adopt MIPv6 is not yet defined. Solutions enabling Mobile IPv6 operation within CDMA2000 would thus be very desirable. Hereby, appropriate mechanisms for matters related to authentication are crucial. Moreover, in order to enable smooth Mobile IPv6 Operation, it is often desirable to shorten the handoff times when the MN becomes temporarily unreachable as it moves to a new domain and acquires a new authorized CoA.

Thus, there is a considerable need for a MIPv6 authentication mechanism that is suitable for CDMA2000 and similar CDMA frameworks and in particular for a mechanism allowing comparatively short handoff/setup times.

### SUMMARY

A general object of the present invention is to support MIPv6 service in CDMA systems. A specific object of the invention is to enable MIPv6 authentication and/or authorization within frameworks such as CDMA2000 and CDMAOne. Another object is to achieve improved packet data session setup times for MIPv6 communication in CDMA systems. It is also an object of the invention to provide a general mechanism for MIPv6 hand-in within the CDMA framework.

These objects are achieved in accordance with the attached claims.

The invention basically relates to authentication and authorization support for MIPv6 in a CDMA framework, and is based on transferring MIPv6-related information in an authentication protocol in an end-to-end procedure between a mobile node in a visited network and the home network of the mobile node over an AAA infrastructure. The MIPv6-related information may typically comprise MIPv6 authentication, authorization and/or configuration information. The authentication protocol is preferably an extended authentication protocol but entirely newly defined protocols can also be used.

Preferably, the end-to-end procedure is executed between the mobile node and an AAA server of the home network, with appropriate interaction with a home agent as and when necessary. In the visited network, after lower-layer setup (including wireless link setup), point-to-point communication is for example established between the mobile node and a suitable CDMA-specific internetworking access server, such as a Packet Data Serving Node (PDSN). The access server/PDSN then communicates with the AAA home network server for MIPv6 authentication and authorization of the mobile node more or less directly or via an AAA server in the visited network.

For example, the invention may use the Extensible Authentication Protocol (EAP) as basis for the extended authentication protocol, creating EAP extensions while typically keeping the EAP lower layer(s) intact. This normally means that the MIPv6-related information is incorporated as additional data in the EAP protocol stack.

The authentication protocol is preferably carried by PPP (Point-to-Point Protocol), CSD-PPP (Circuit Switched Data-PPP), or PANA (Protocol for carrying Authentication for Network Access) between the mobile node and the access server (PDSN), and by an AAA framework protocol application such as Diameter and Radius within the AAA infrastructure between the access server (PDSN) and the AAA home network server.

Initialization and configuration of the point-to-point communication between the mobile node and the access server (PDSN) is preferably accomplished by using e.g. PPP or CSD-PPP, where the use of CSD-PPP considerably reduces the number of round trips and thus shortens the packet data session setup time. Advantageously, the access server (PDSN) initially offers the mobile node the possibility to use CSD-PPP as an alternative to PPP, for example by sending out a standard PPP/LCP packet, immediately followed by a PPP/CHAP and/or a PPP/EAP packet. The mobile node can then choose between PPP and CSD-PPP. If the mobile node opts for using PPP it then ignores messages that are not PPP/LCP. If the mobile opts for using CSD-PPP, LCP (Link Control Protocol), network authentication and NCP (Network Control Protocol) phases can be processed concurrently.

Three main scenarios for MIPv6 authentication and/or authorization have been identified: MIPv6 initiation, MIPv6 hand-in, and MIPv6 re-authentication. EAP extensions adapted for MIPv6 are preferably used for MIPv6 initiation and re-authentication, while the use of CHAP (Challenge Handshake Authentication Protocol) has turned out to be beneficial for MIPv6 hand-in with MIPv6 authentication.

By means of the present invention, a complete overall-solution for MIPv6 authentication in the CDMA framework is accomplished for the first time, while in the prior art there have only been partial solutions non-consistent with each other. By employing CSD-PPP in this context, the packet data session setup time can be considerably shortened. Moreover, relying on authentication protocol extensions like EAP extensions provides a streamlined solution, which is manageable and elegant with a minimum of backward compatibility problems. The use of EAP also allows the AAA components in the visited network to be agnostic to the MIPv6 procedures (i.e. this removes the dependency on MIPv6 support in the visited network), and act as mere pass-through agent(s), at least when the HA is located in the home network.

The proposed solution is especially suitable for MIPv6 authentication within CDMA2000 e.g. in accordance with 3GPP2 specifications, but may also be used in other frameworks, such as CDMAOne or future CDMA frameworks.

### BRIEF DESCRIPTION OF THE DRAWINGS

The invention may best be understood by reference to the following description and the accompanying drawings, in which:

FIG. 1 illustrates the general 3GPP2 reference model for Mobile IP Access;

FIG. 2 is a schematic view of a CDMA network for Mobile IP access in which the present invention may be used;

FIG. 3 is a signal flow diagram for generally handling MIPv6 initiation in accordance with an exemplary embodiment of the present invention;

FIG. 4 is a signal flow diagram for generally handling MIPv6 initiation in accordance with another exemplary embodiment of the present invention;

FIG. 5 is a signal flow diagram of MIPv6 initiation with MIPv6 authentication in accordance with an exemplary embodiment of the present invention;

FIG. 6 is a signal flow diagram of MIPv6 initiation with MIPv6 authentication in accordance with another exemplary embodiment of the present invention;

FIG. 7 is a signal flow diagram of MIPv6 initiation with MIPv6 authentication in accordance with still another exemplary embodiment of the present invention;

FIG. 8 is a signal flow diagram of MIPv6 hand-in with MIPv6 authentication in accordance with an exemplary embodiment of the present invention;

FIG. 9 is a signal flow diagram of MIPv6 hand-in with MIPv6 authentication in accordance with another exemplary embodiment of the present invention;

FIG. 10 is a signal flow diagram of MIPv6 re-authentication in accordance with an exemplary embodiment of the present invention;

FIG. 11 is a signal flow diagram of MIPv6 re-authentication in accordance with another exemplary embodiment of the present invention;

FIG. 12 is a schematic block diagram of an internetworking access server in accordance with an exemplary embodiment of the present invention;

FIG. 13 is a schematic block diagram illustrating an AAA home network server in accordance with an exemplary embodiment of the present invention; and

FIG. 14 is a schematic flow diagram of a basic example of a method for supporting MIPv6 service for a mobile node in a .CDMA system in accordance with the present invention.

### DETAILED DESCRIPTION

A list of abbreviations used in this document is presented at the end of the description.

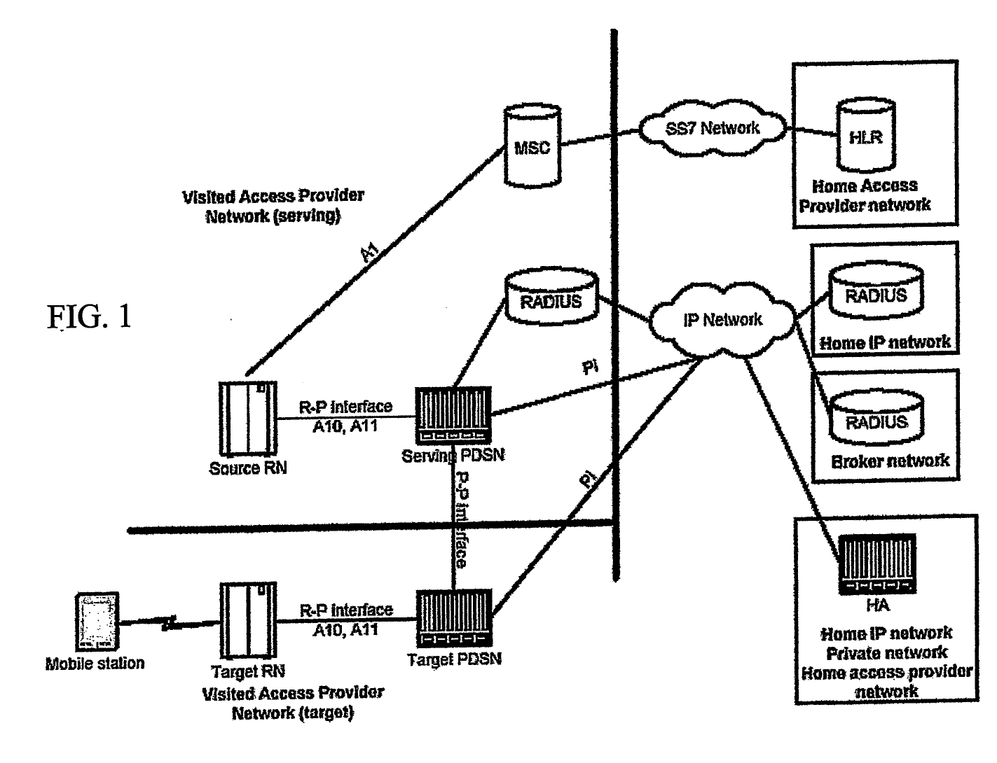

FIG. 1 shows the general 3GPP2 reference model for Mobile IP Access. A situation where a mobile station is handed over from a source RN and a serving PDSN to a target RN and a target PDSN is illustrated. The AAA servers of FIG. 1 are exemplified as RADIUS servers but can very well be replaced with other AAA servers, including servers operating in accordance with the Diameter protocol.

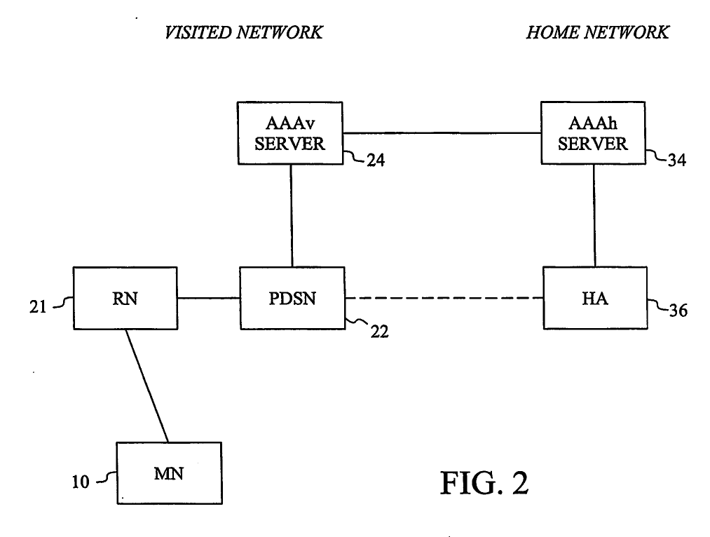

FIG. 2 is a schematic view of a CDMA communication system for Mobile IP access in which the present invention may be used. The schematic CDMA architecture of FIG. 2 can be viewed as a simplified and generalized version of the model in FIG. 1. A mobile node (MN) 10, e.g. a cellular phone, a laptop or a PDA, roaming in a foreign/visited network other than its associated home network is shown. In the visited network, the MN 10 communicates with an internetworking access server exemplified as a packet data serving node (PDSN) 22 over a radio network (RN) 21, which manages the physical layer connection to the MN 10. The internetworking access server 22 provides internetworking between the radio and IP networks, and is in a sense comparable to an AAA client acting as a foreign agent. Although PDSN is the specific node used in CDMA2000, equivalents can be found in other CDMA frameworks. Thus, the PDSN typically initiates authentication, authorization and accounting for the MN 10.

As illustrated in FIG. 2, the PDSN 22 connects to a Home Agent (HA) 36 in the home network of the MN 10 over an AAA infrastructure comprising one or more AAA servers 24, 34. The HA 36 is typically maintained by the service provider of the user and manages user registration and redirection of packets to the PDSN, for example.

The overall purpose of the AAA servers is to interact with the PDSN and other AAA servers to authorize, authenticate and (optionally) perform accounting for the mobile client. This normally involves providing mechanisms by means of which security associations can be accomplished between the MN 10 and HA 36.

Mobile IP authentication and authorization often involves the following basic steps.

The MN 10 connects to the nearest PDSN/foreign agent 22. The PDSN in turn contacts the AAAh server 34, normally via the AAAv server 24, with an access request message to authenticate the user and obtain the appropriate tunneling parameters, IP address etc. If the authentication is successful, the AAA server(s) authorizes the user and a security association between the MN 10 and the HA 36 can be established. It is normally the HA 36 that assigns the IP address and routes user traffic.

To our knowledge, no complete solution for authentication and/or authorization support of MIPv6 has been presented in the prior art. Some proposals target portions of the end-to-end AAA chain (e.g. [3] for the part between AAA Client and AAA servers, and PANA [4] protocol for the part between MN and AAA Client), but these partial solutions are not consistent with each other and do not work end-to-end. Moreover, the conventional mechanism of [3] requires the AAA Client and AAAv to understand the authentication method and be aware of the contents of the exchanges of MIPv6-related data between the MN and the AAAh. With such a solution it is not possible to apply prior encryption between MN and AAAh, and the system becomes highly vulnerable with respect to eavesdropping, man-in-the-middle attacks and the like.

In particular, as mentioned in the background section, there is no prior-art mechanism for MIPv6 authentication and/or authorization in frameworks like CDMA2000, and the need for such a mechanism, in particular one associated with comparatively short handoff/setup times is considerable.

To meet this need, the present invention proposes to employ an authentication protocol in an end-to-end procedure between a mobile node in a visited network and the home network of the mobile node over an AAA infrastructure, preferably combining protocols like the above PPP, CSD-PPP, PANA and Diameter/Radius protocols in a new way to achieve an authentication and/or authorization procedure appropriate for CDMA systems such as CDMA2000. The MIPv6-related information preferably comprises authentication, authorization and/or configuration information that is transferred over the AAA infrastructure for establishing a MIPv6 security association (i.e. security relation) or binding between the mobile node and a home agent.

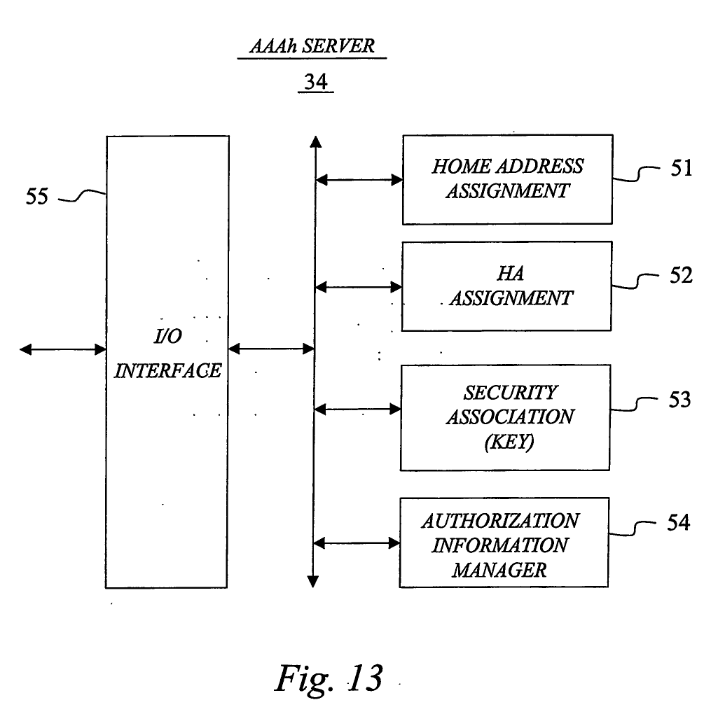

Preferably, the end-to-end procedure is executed between the mobile node and an AAA server of the home network with appropriate interaction with a home agent as and when necessary. FIG. 13 is a schematic block diagram of a preferred embodiment of such an AAA home network server according to the invention. In this example, the AAAh server 34 basically comprises a home address assignment module 51, a home agent (HA) assignment module 52, a security association module 53, an authorization information manager 54 and an input-output (I/O) interface 55. The module 51 preferably performs home address assignment (unless the home address is configured at the mobile node and sent to the HA), and the module 52 is operable for assigning and/or re-assigning a suitable home agent (HA). The AAAh server 34 typically also receives a key seed and a binding update (BU) from the mobile node. Alternatively the AAAh server 34 generates the key seed itself and sends it to the mobile node. The security association module 53 preferably generates the required security key in response to the seed, and securely transfers this key to the HA. The binding update (BU) is also forwarded to the home agent (HA) so that the HA may cache the binding of the home address with the care-of address of the mobile node. The AAAh server may also receive information, such as IPSec information, from the HA for finalizing the security association. This information together with other collected authorization (and/or configuration) information may then be stored in the optional authorization information manager 54 for subsequent transfer to the mobile node.

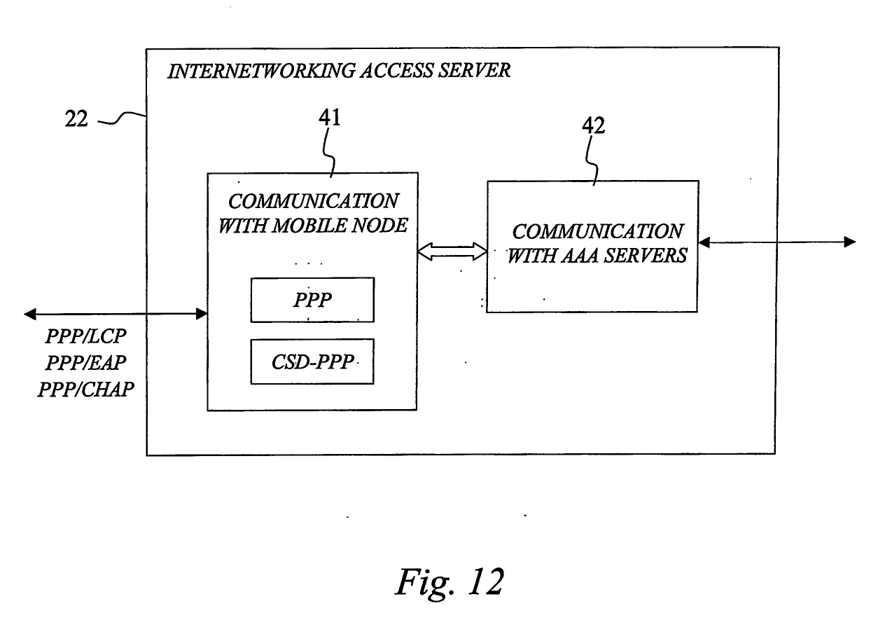

In the visited network, point-to-point communication is typically established between the mobile node and a suitable internetworking access server such as a PDSN that for example provides the required internetworking between the radio and IP networks. FIG. 12 is a schematic block diagram of a preferred embodiment of such an internetworking access server. The internetworking access server 22 comprises a module 41 for communication with mobile nodes, e.g. via PPP or CSD-PPP, as well as a module 42 for communication with AAA servers and similar nodes.

The authorization phase naturally includes explicit authorization but may also include configuration of the involved nodes. MIPv6-related configuration such as configuration of the mobile node and/or configuration of the HA is therefore normally regarded as part of the overall authorization procedure.

The term “AAA” should be taken within its general meaning of Internet drafts, RFCs and other standardization documents. Typically, the authentication and security key agreement of an AAA (Authorization, Authentication, and Accounting) infrastructure is based on symmetric cryptography, implying the existence of an initial secret shared between the mobile node and the home network operator or a trusted party. In some scenarios and applications, for example the accounting feature of the AAA infrastructure may be disabled or not implemented. The AAA infrastructure generally includes one or more AAA servers, in the home network and/or the visited network, and may also include one or more AAA clients. Optionally, there can also be one or more intermediate networks included in the AAA infrastructure.

In the following, some basic features for MIPv6 authentication and/or authorization in the CDMA framework will be outlined with reference to three main MIPv6 scenarios: MIPv6 initiation, MIPv6 hand-in, and MIPv6 re-authentication.

For MIPv6 initiation, when there is no prior MIPv6 service available, lower-layer configuration is performed including wireless link setup, and then the point-to-point communication between the mobile node and the PDSN or equivalent node in the visited network has to be initialized and configured. The configuration of the point-to-point communication is preferably accomplished by using e.g. PPP or CSD-PPP. The use of CSD-PPP considerably reduces the number of round trips and thus shortens the packet data session setup time.

The invention preferably uses an extended authentication protocol as basis for the authentication protocol transferring the MIPv6-related data, which in the following will primarily be exemplified by such an extended protocol. For example, the invention may use the Extensible Authentication Protocol (EAP) as basis for the extended authentication protocol, incorporating MIPv6-related information for authentication, authorization and/or configuration as additional data in the EAP protocol stack. Still, it should be emphasized that the authentication protocols built from scratch also lie within the scope of the invention.

Once the communication between the mobile node and the PDSN or equivalent node is configured, the extended authentication protocol may be carried, e.g. by PPP, CSD-PPP, or PANA between the mobile node and the PDSN, and by an AAA framework protocol application such as Diameter and RADIUS within the AAA infrastructure to the AAA home network server.

For IP address assignment purposes, it is for example possible to use DHCP for IP address assignment. Alternatively, the NCP (IPv6CP) phase of PPP/CSD-PPP can be used for Interface-ID assignment, and IPv6 router solicitation/advertisement for obtaining the global prefix for the IPv6 address. For general information on address configuration in IPv6, reference is made to [5].

For MIPv6 hand-in, when there is a handover that requires re-establishment of the necessary bearers for an ongoing MIPv6 service to be able to continue, it has turned out to be beneficial to employ the CHAP protocol for authentication, for example using PPP or CSD-PPP for configuration of point-to-point communication and as a protocol carrier.

For MIPv6 re-authentication, for example when the trust relationship between the mobile node and the home agent expires, there is normally already an established point-to-point communication between the mobile node and the PDSN. In similarity to the MIPv6 initiation case, the extended authentication protocol is preferably carried by PPP or PANA between the mobile node and the PDSN, and by an AAA framework protocol application such as Diameter and Radius within the AAA infrastructure to the AAA home network server.

As mentioned above, the extended authentication protocol (e.g. extended EAP) can for example be carried between the MN 10 and the PDSN 22 (or a corresponding node) by PANA or PPP. Alternatively, other carrier protocols associated with satisfactory lower layer ordering guarantees, such as IEEE 802.1X [6], might be used to carry the extended authentication protocol. For 3GPP2 CDMA2000 systems, it is possible to use PPP Data Link Layer protocol encapsulation with the protocol field value set to C227 (Hex) for EAP [7].

It should be emphasized that although the invention is very advantageous for CDMA2000, it can also be used in other frameworks, such as e.g. CDMAOne and other (current or future) frameworks/operating modes based on CDMA technology.

In the following paragraphs, some general aspects of the above-mentioned use of PPP and CSD-PPP protocols for configuration of point-to-point communication and/or as carriers for the extended authentication protocol (e.g. extended EAP) and/or CHAP will be described.

Within 3GPP2 CDMA2000, PPP [8] can be used for setup of packet data sessions in connection with both Mobile and Simple IP Operations, hence the necessary PPP exchanges fall within the delay critical path during handoffs. The usage of PPP as specified in 3GPP2 CDMA2000 differs for the case of Simple IPv4/IPv6 Operation and Mobile IPv4 Operation. For Simple IPv4/IPv6 Operation, the authentication phase of PPP is used for CHAP authentication, while the NCP (IPCP/IPv6CP [9]) phase of PPP is used for IP address assignment. For Mobile IPv4 Operation, no authentication phase is carried out within PPP, and no IP address is requested at NCP (IPCP) phase of PPP.

In the prior art, no specifications/definitions have been made regarding usage of PPP for Mobile IPv6 Operation in CDMA systems. However, a strong requirement upon solutions for usage of PPP for Mobile IPv6 Operation would be that they are at least backward compatible with the current PPP usage. This requirement is fulfilled in accordance with some advantageous embodiments of the present invention, which introduce the use of CSD-PPP in connection with Mobile IPv6 support in CDMA systems. Besides ensuring interoperability with current PPP usage, CSD-PPP results in a considerably shortened configuration time in cases where both peer protocol entities can be adapted according to CSD-PPP.

Basically, the shortened configuration time is achieved by modifying PPP. The general idea is that when 2 CSD-PPP peers communicate, the strict separation of LCP, authentication, and NCP phases of PPP will not be required anymore. That is, LCP, authentication, and NCP phases can take place concurrently to shorten the overall PPP configuration time. Also, where one PPP peer is and the other is not modified according to CSD-PPP, the modified peer will fall back to conform with PPP. This is carried out in a way that neither decreases nor increases the PPP configuration time. Information about the general CSD-PPP mechanism can for example be found in [10].

For a better understanding of the invention, exemplary extended authentication protocols according to preferred embodiments of the invention will now be described.

These exemplary embodiments use EAP as basis for the extended authentication protocol, creating EAP extensions while typically keeping the EAP lower layer(s) intact. It should however be understood that the invention is not limited thereto and that other general authentication protocols may be extended in a similar manner. For the particular case of EAP, the MIPv6-related information is normally incorporated as additional data in the EAP protocol stack, typically by means of one or more new EAP attribute(s). Different solutions for implementing such EAP attributes are described in the sections “Method-specific EAP attributes” and “Generic container attribute” below.

Method-Specific EAP Attributes

In accordance with one particular embodiment of the present invention the MIPv6-related information is transferred as EAP attributes in the EAP method layer of the EAP protocol stack. A new (extended) EAP authentication protocol is then defined to carry a method for MIPv6 authentication. The extended EAP protocol should preferably enable negotiation/enforcement of MIPv6 authentication and may also support some auxiliary information that facilitate e.g. dynamic MN home address allocation, dynamic HA allocation, distribution of security keys between HA and MN, and distribution of security keys between PAC and PAA for PANA security.

The new EAP attributes can for instance be new EAP TLV attributes and examplary protocol details will now be provided to show the overall flow and viability of concept.

The following EAP-TLVs are examples of new EAP TLVs that may be defined under the extended EAP protocol of the present invention:
i) MD5 Challenge EAP-TLV attribute
ii) MD5 Response EAP-TLV attribute
iii) MIPv6 Home Address Request EAP-TLV attribute
iv) MIPv6 Home Address Response EAP-TLV attribute
v) MIPv6 Home Agent Address Request EAP-TLV attribute
vi) MIPv6 Home Agent Address Response EAP-TLV attribute
vii) HA-MN Pre-shared Key Generation Nonce EAP-TLV attribute
viii) IKE KeyID EAP-TLV attribute
ix) HA-MN IPSec SPI EAP-TLV attribute
x) HA-MN IPSec Key Lifetime EAP-TLV attribute
xi) PAC-PAA Pre-shared Key Generation Nonce EAP-TLV attribute
xii) MIPv6 Home Address EAP-TLV attribute
xiii) HA-MN Pre-shared Key EAP-TLV attribute
xiv) HA-MN IPSec Protocol EAP-TLV attribute
xv) HA-MN IPSec Crypto EAP-TLV attribute
xvi) MIP-Binding-Update EAP-TLV attribute
xvii) MIP-Binding-Acknowledgement EAP-TLV attribute

By means of (a subset or all of) these attributes, the EAP protocol can, in addition to the main IPv6 authentication information, carry MIPv6-related auxiliary information, which is a considerable advantage. The MIPv6-related auxiliary information can e.g. comprise requests for dynamic MN home address allocation, dynamic Home Agent allocation, as well as nonces/seeds for creation of necessary security keys.

The authentication mechanism of the extended EAP protocol in accordance with the present invention can for example use MD5-Challenge authentication but other types of protocols also lie within the scope of the invention. The following EAP-TLV attributes can be defined for MIPv6 authentication in the case with implementation through MD5-Challenge authentication:

i) AD5 Challenge EAP-TLV Attribute

This represents the octet string generated randomly by the AAAh and sent to MN for MD5 challenge.

ii) MD5 Response EAP-TLV Attribute

This represents the octet string generated as a result of the MD5 hash function with the shared secret key between AAAh and MN.

In case MIPv6-related information that facilitates dynamic MN home address allocation is to be transferred, the following EAP-TLV attributes can for example be defined:

iii) MIPv6 Home Address Request EAP-TLV Attribute

This represents a request for a dynamically allocated MIPv6 home address for the authenticated MN. It will be requested from the AAAh by the MN when the MN initially requests to be authenticated and given MIPv6 service. This EAP attribute is normally defined as an optional attribute when the MN already has a previously assigned home address, such as during MIPv6 handoffs.

iv) MIPv6 Home Address Response EAP-TLV Attribute

This represents a dynamic allocated MIPv6 home address for the authenticated MN. It will be notified to the MN from AAAh when the MN, which has requested a home address, is successfully authenticated. This attribute is normally optional when the MN already has a previously assigned home address, such as during MIPv6 handoffs.

For dynamic HA allocation, the following exemplary EAP-TLV attributes can be used:

v) MIPv6 Home Agent Address Request EAP-TLV Attribute

This represents a request for an address of a dynamically allocated HA for the MN when successfully authenticated. It will be requested from the AAAh by the MN when the MN initially requests to be authenticated and given MIPv6 service. In cases where HA allocation is already at hand, such as when the dynamic HA discovery method of the MIPv6 protocol is used to allocate the HA or when the MN already has a previously assigned HA (e.g. during MIPv6 handoffs), this attribute is normally defined to be optional.

vi) MIPv6 Home Agent Address Response EAP-TLV Attribute

This represents an address of a dynamic allocated HA for the authenticated MN. It will be notified to the MN from the AAAh when the MN initially requests to be authenticated and given MIPv6 service. Since the MIPv6 protocol has a dynamic home agent discovery method for home agent allocation, this attribute would normally be optional. This is also the case when the MN already has a previously assigned HA, e.g. during MIPv6 handoffs.

The following exemplary EAP-TLV attributes can be defined for distribution of security keys between HA and MN:

vii) HA-MNPre-Shared Key Generation Nonce EAP-TLV Attribute

This represents the octet string generated randomly by MN as a seed for generating a pre-shared key between HA-MN. The MN can internally generate the HA-MN pre-shared key by using an appropriate hash algorithm on the combination of this nonce and the shared key between MN and AAAh. This attribute would normally be optional when a valid HA-MN pre-shared key already exists, for example during MIPv6 handoffs.

viii) IKE KeyID EAP-TLV Attribute

This represents the ID payload defined in [11]. The KeyID is generated by the AAAh and sent to the MN upon successful authentication. The KeyID includes some octets which informs the HA about how to retrieve (or generate) the HA-MN pre-shared key from AAAh. This attribute is typically defined to be optional, and would generally not be needed when the MN has not submitted a HA-MN pre-shared key generation nonce, i.e. a valid HA-MN pre-shared key already exists, e.g. during MIPv6 handoffs. Nor will it normally be needed in the case when the HA-MN pre-shared key is conveyed by the AAAh to the HA via the AAAh-HA interface defined in [12].

ix) HA-MN IPSec SPIEAP-TLV Attribute

This represents the Security Parameter Index for IPSec between the HA and MN. This attribute is generated by the HA and communicated to the MN in case the HA-MN pre-shared key is conveyed by the AAAH to the HA via the AAAh-HA interface defined in [12]. This attribute would typically be optional and is generally not needed when the MN has not submitted a HA-MN pre-shared key generation nonce, i.e. a valid HA-MN pre-shared key already exists, e.g. during MIPv6 handoffs. It is also not needed when the AAAh-HA interface defined in [12] is not used.

x) HA-MNIPSec Key Lifetime EAP-TLV Attribute

This represents the Key Lifetime for IPSec between the HA and MN. This attribute is generated by the HA and communicated to the MN in case the HA-MN pre-shared key is conveyed by the AAAh to the HA via the AAAh-HA interface defined in [12]. This attribute is typically optional and generally not needed when the MN has not submitted a HA-MN pre-shared key generation nonce, i.e. a valid HA-MN pre-shared key already exists, e.g. during MIPv6 handoffs. It would typically also not be needed when the AAAh-HA interface defined in [12] is not used.

In case PANA is used to carry the extended EAP protocol between MN and PDSN/AAA client, the following exemplary EAP-TLV attribute can be defined for distribution of security keys between MN/PAC and PDSN/AAA client/PAA for PANA security:

xi) PAC-PAA Pre-shared Key Generation Nonce EAP-TLV Attribute

This represents the octet string generated randomly by MN/PAC as a seed for generating the pre-shared key between MN/PAC and PDSN/AAA client/PAA. The MN/PAC can internally generate the PAC-PAA pre-shared key by using an appropriate hash algorithm on the combination of this nonce and the shared key between MN and AAAh. By means of this attribute satisfactory PANA security can be achieved. Finally, the following optional EAP-TLV attributes may be defined for special MIPv6 purposes:

xii) MIPv6 Home Address EAP-TLV Attribute

This represents a dynamic allocated MIPv6 home address for the authenticated MN. It will be notified to the HA from AAAH in order to assign the MIPv6 home address in the HA, when the MN, which has requested for one, has been successfully authenticated.

xiii) HA-MNPre-shared Key EAP-TLV Attribute

This represents a dynamically generated pre-shared key between HA-MN. It will be notified to the HA from the AAAh when a MN requests to be authenticated and given MIPv6 service. The AAAh can internally generate the HA-MN pre-shared key by using an appropriate hash algorithm on the combination of the nonce given by the HA-MN Pre-shared Key Generation Nonce EAP-TLV Attribute and the shared key between MN and AAAh. This attribute is optional when a valid HA-MN pre-shared key already exists.

xiv) HA-MNIPSec Protocol EAP-TLV Attribute

This represents the IPSec Protocol (e.g. ESP or AH) between HA-MN. This is informed to the MN for the case when the HA-MN pre-shared key is conveyed by the AAAh to the HA. This attribute is optional and is generally not needed when the MN did not submit a HA-MN pre-shared key generation nonce, i.e., a valid HA-MN pre-shared key already exists, e.g., during MIPv6 handoffs.

xv) HA-MNIPSec Crypto EAP-TLV Attribute

This represents the Cryptographic Algorithm for IPSec between HA-MN. This is informed to the MN for the case when the HA-MN pre-shared key is conveyed by the AAAh to the HA. This attribute is optional and is generally not needed when the MN did not submit a HA-MN pre-shared key generation nonce, i.e., a valid HA-MN pre-shared key already exists, e.g., during MIPv6 handoffs.

xvi) MIP-Binding-Update EAP-TLV Attribute

This represents the Binding Update packet generated by the MN. This is forwarded to the HA via AAAh from the MN in the authentication and authorization exchanges. This attribute is optional and is generally not needed when the MN sends Binding Update packet directly to HA.

xvii) MIP-Binding-Acknowledgement EAP-TLV Attribute

This represents the Binding Acknowledgement packet generated by the HA. This is forwarded to the MN via AAAh from the HA in the authentication and authorization exchanges. This attribute is optional and is generally not needed when the HA sends Binding Acknowledgement packet directly to MN.

A summary matrix of the described examplary EAP-TLVs for transfer of MIPv6-related information is given in Table 1.

TABLE 1

| MIPv6-related EAP Type-Length-Values | Source | Destination | Purpose |
|---|---|---|---|
| MD5 Challenge EAP-TLV attribute | AAAh | MN | issue challenge |
| MD5 Response EAP-TLV attribute | MN | AAAh | provide response to challenge |
| MIPv6 Home Address Request EAP-TLV attribute | MN | AAAh | request MN home address |
| MIPv6 Home Address Response EAP-TLV attribute | AAAh | MN | assign MN home address |
| MIPv6 Home Agent Address Request EAP-TLV attribute | MN | AAAh | request HA address |
| MIPv6 Home Agent Address Response EAP-TLV attribute | AAAh | MN | assign HA address |
| HA-MN Pre-shared Key Generation Nonce EAP-TLV attribute | MN | AAAh | seed for HA-MN key |
| IKE KeyID EAP-TLV attribute | AAAh | MN | info for obtaining HA-MN pre-shared key from AAAh |
| HA-MN IPSec SPI EAP-TLV attribute | HA | MN via AAAh | assign SPI |
| HA-MN IPSec Key Lifetime EAP-TLV attribute | HA | MN via AAAh | assign IP Sec Key lifetime |
| PAC-PAA Pre-shared Key Generation Nonce EAP-TLV attribute | MN | AAAh | seed for PAC-PAA key |
| MIPv6 Home Address EAP-TLV attribute | AAAh | HA | assign MN Home Address |
| HA-MN Pre-shared Key EAP-TLV attribute | AAAh | HA | assign HA-MN key |
| HA-MN IPSec Protocol EAP-TLV attribute | HA | MN via AAAh | assign IPSec Protocol |
| HA-MN IPSec Crypto EAP-TLV attribute | HA | MN via AAAh | assign IPSec Crypto |
| MIP-Binding-Update EAP-TLV attribute | MN | HA via AAAh | piggyback MIP binding update |
| MIP-Binding-Acknowledgement EAP-TLV attribute | HA | MN via AAAh | piggyback MIP binding ack. |

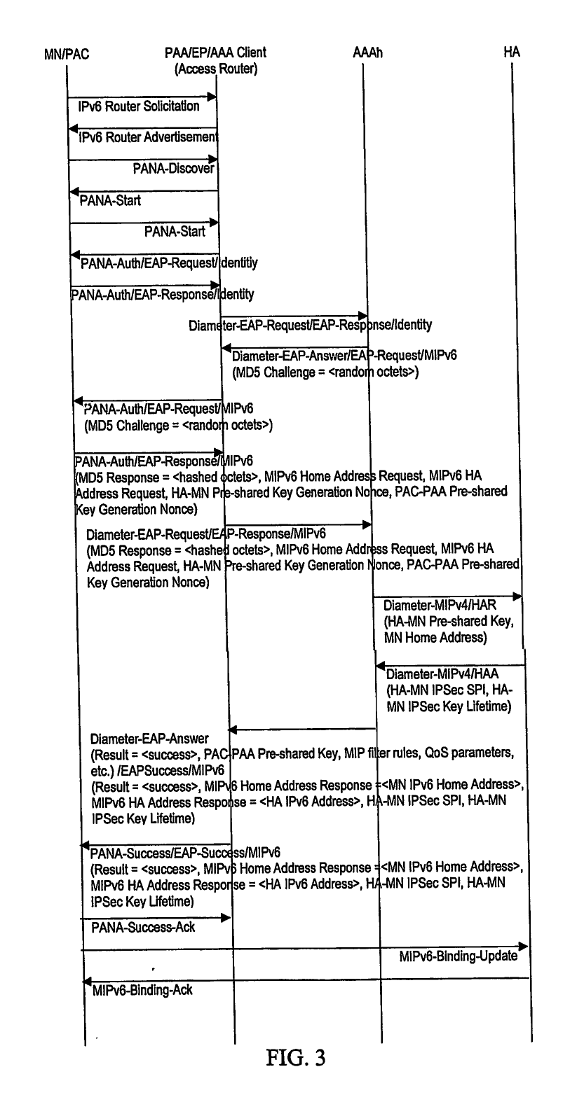

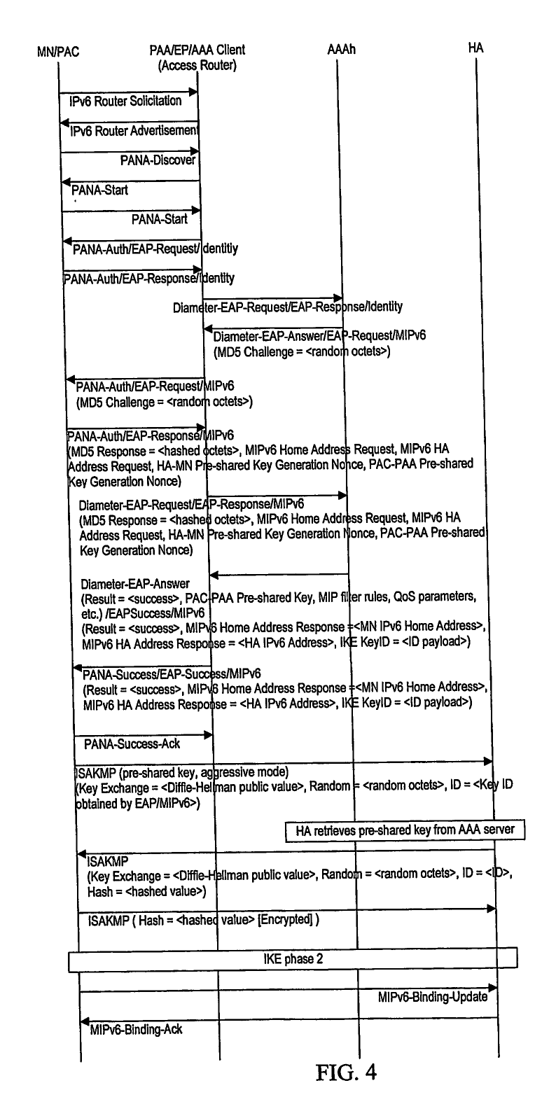

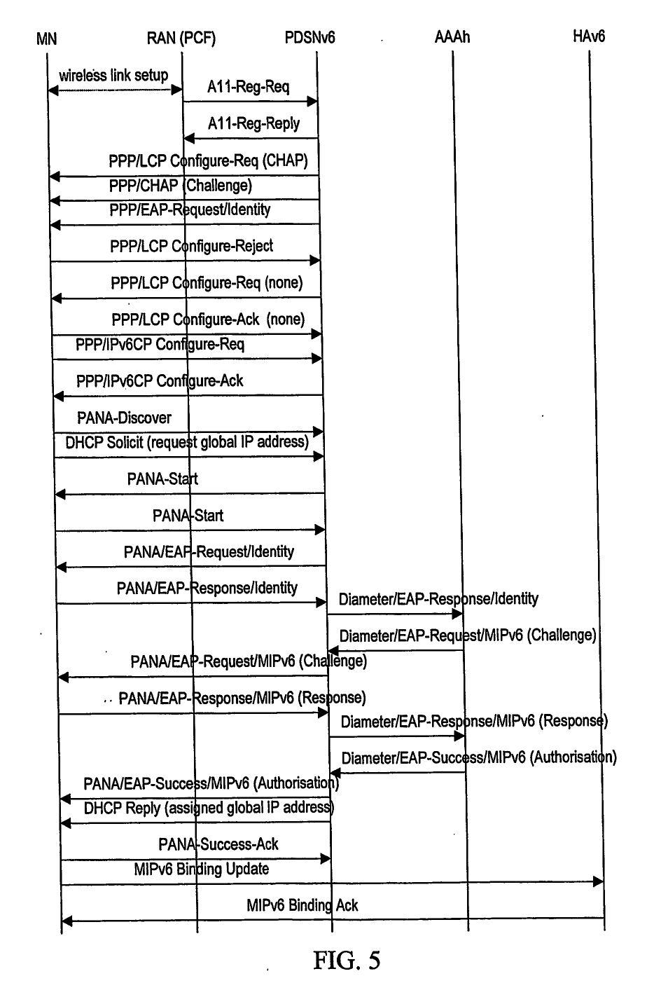

Exemplary schemes for handling MIPv6 initiation according to the invention are provided in the signaling flow diagrams FIGS. 3 and 4. Transfer of MIPv6-related information implemented using the above-described exemplary EAP TLV attributes between the MN, access router, AAAh and HA is shown. The access router can for example comprise PDSN functionality, in this respect corresponding to AAA client functionality. The term “EAP/MIPv6” refers to the new extended EAP protocol that is used to transfer the MIPv6-related information over the AAA infrastructure in preferred embodiments of the invention. The particular examples of FIGS. 3 and 4 relate to MIPv6 AAA using a combination of PANA and Diameter as carrier protocols, but the invention is not limited thereto as will later be appreciated from the flow diagrams of FIGS. 5-11. The flow diagram in FIG. 3 illustrates MIPv6 initiation with use of an AAAh-HA interface according to [12] for exchange of a HA-MN pre-shared key. Another embodiment of the MIPv6 initiation mechanism, illustrated in FIG. 4, uses IKE KeyID for exchange of a HA-MN pre-shared key.

Generic Container Attribute

In another embodiment of the present invention, the MIPv6-related information is carried in a generic container EAP attribute that preferably can be used together with any EAP method included in any EAP packet. EAP is thus augmented with a generic container attribute (also referred to as GCA) that can be used to carry non-EAP related data, more specifically MIPv6-related data, between the MN 10 and the AAAh 34. This allows the MN and the AAAh to communicate in a manner that is transparent to the visited domain, including the access network, the PDSN/AAA client and the AAAv 24. Thus, just as in the above described case with method-specific EAP TLV attributes, the AAA infrastructure is exploited to support MIPv6 related features in a way that is preferably transparent to the visited domain. The solution can for example support dynamic HA assignment in the home network (including the home network prefix); distribution of MN-HA credentials; MIPv6 message encapsulation; a single authenticating entity for network access and MIPv6; and/or stateful dynamic home address assignment.

When using the generic container attribute, EAP is preferably used as a carrier of MIPv6 related data without creating a new EAP method. However, another variant is to introduce the generic container attribute in one (or more) EAP method(s) on the method layer of the protocol stack. A new EAP method for transfer of the MIPv6-related data is hereby defined and the generic container attribute is used in this new EAP method. In other words, the generic container attribute can be method specific in a manner similar to that described in association with the EAP TLV attributes.

As before, EAP is carried in an AAA framework protocol, such the Diameter EAP Application [13] or RADIUS [14, 15], between the PDSN/AAA client 22 and the AAAh 34. However, it is also proposed to use a new/extended Diameter application (or RADIUS extended with new attributes) to exchange AAA and MIPv6 data between the AAAh 34 and the HA 36. This Diameter application can be an extended version of an existing Diameter application, e.g. the Diameter EAP Application [13], or a new Diameter application. This new/extended new Diameter application (or extended RADIUS) is henceforth referred to as a “Diameter MIPv6 application”. It should be emphasized that this reference is used only for simplicity and does not exclude use of extended RADIUS or other methods for AAAh-HA communication.

Preferred ways of handling the authentication procedure, including assignment of home agents and home addresses, using generic container attributes in accordance with the present invention will now be described, primarily using the EAP protocol as an example and with reference to FIG. 2.

During the authentication procedure the MN 10 indicates to the AAAh 34 through the generic container attribute that it wishes to have a HA 36 assigned in the home network. There are now three main cases to consider:
A) The MN already has a valid home address.
B) Stateful dynamic home address assignment is used.
C) Stateless home address autoconfiguration is used.

If the MN 10 already has a home address (A), it sends it to the AAAh 34 together with a request for a home agent address. If the AAAh determines that the home address is valid, it selects a HA 36 and generates MN-HA credentials, such as a pre-shared key or data from which a pre-shared key can be derived. The home address of the MN and the generated MN-HA credentials can for example be sent to the selected HA via the Diameter MIPv6 Application. The address of the selected HA and the generated credentials (or data from which the generated credentials can be derived) are sent to the MN via the extended authentication protocol e.g. extended EAP. If, for example, a pre-shared key is sent to the MN, it has to be protected (encrypted and integrity protected) by keys derived from the security relation between the AAAh and the MN (e.g. session keys produced during the authentication procedure). Otherwise the pre-shared key should not be sent explicitly. Instead, a piece of data from which the pre-shared key (or other credentials) can be derived based on the MN-AAAh security relation, e.g. a nonce, can be sent (e.g. a RAND parameter to be fed into the AKA or GSM authentication algorithm if EAP AKA [16] or EAP SIM [17] is used). If cryptographic protection is applied to the credentials, it may be convenient to use the same kind of protection for the HA address and the home address.

When the network access authentication is finalized and the MN is authorized to access the network beyond the access server (e.g. a WLAN AP or an access router), the MN can establish IPsec SAs towards the assigned HA via IKE (e.g. IKEv1 or IKEv2) procedures based on the obtained credentials. This procedure and the subsequent BU/BA exchange are carried out using conventional IKE and MIPv6 mechanisms.

If the MN either includes no home address at all or includes a home address that is no longer valid (e.g. due to MIPv6 home network renumbering) in its request for a home agent, a home address should be assigned to the MN. For this, the present invention proposes mechanisms for stateful dynamic home address assignment (B) or stateless home address autoconfiguration (C).

The present invention enables stateful dynamic home address assignment (B), whereby the AAAh 34 assigns a home address to the MN 10. The AAAh also generates MN-HA credentials, which it preferably sends to the selected HA 36 together with the assigned home address via the Diameter MIPv6 Application. The AAAh also sends the assigned home address together with the address of the assigned HA and the generated credentials (or data from which the generated credentials can be derived) to the MN via the extended authentication protocol of the invention, exemplified by extended EAP. As in case (A), either the MN-HA credentials are protected before being sent over the extended authentication protocol or, alternatively, data from which the credentials can be derived, e.g. a nonce, is sent instead of the actual credentials. After the network access authentication is concluded, the MN can establish IPsec SAs and perform BU/BA exchange towards the assigned HA using conventional IKE and MIPv6 mechanisms.

In case stateless autoconfiguration of home addresses is used (C), the behavior depends on the number of roundtrips of the selected EAP method. In response to the request for a HA 36 the AAAh 34 returns a HA address together with credentials (or data from which the credentials can be derived) to the MN 10. The MN typically uses the prefix of the received HA address to build a home address. If the EAP procedure is not finalized, i.e. if the HA address was conveyed in an EAP Request packet and not in an EAP Success packet, the MN sends its home address to the AAAh. The AAAh then sends the received home address together with the credentials to the assigned HA. The HA should then perform DAD for the received home address on its subnet. Provided that the DAD is successful, the MN and the HA will later be able to establish IPsec SAs and exchange BU/BA packets using conventional IKE and MIPv6 mechanisms.

If the MN instead receives the HA address in the final packet of the EAP procedure (i.e. the EAP Success packet), it cannot convey its newly built home address to the AAAh. A way to solve this problem of an insufficient number of EAP roundtrips is to let the AAAh increase the number of EAP roundtrips using EAP Notification Request/Response packets for enabling transfer of the generic container attribute.

A major advantage of the described mechanisms is that they simplify configuration of both the MN 10 and the HA 36. The MN can leverage its network access configuration parameters (the NAI and the MN-AAAh security relation) and no MIPv6 specific configuration is needed. The HA does not need any MN specific configuration, since the HA-AAAh security relation is enough. The AAAh 34 can, to a large extent, form a single authenticating entity for both network access and MIPv6 (although IKE authentication may still be performed in the HA based on data received from the AAAh).

If a valid MN-HA security association (e.g. IPsec SA) already is present, the MN 10 does not need to request a HA address from the AAAh 34. Instead it may reduce the overall access delay by encapsulating the BU in the generic container attribute and send it to the AAAh via the extended authentication protocol. The AAAh preferably encapsulates the BU in a Diameter MIPv6 Application message and sends it to the HA 36 indicated by the destination address of the BU. The HA responds with a BA and the AAAh relays the response to the MN. The encapsulated BU and BA are protected by the MN-HA IPsec SAs. According to a preferred embodiment, the AAAh checks that the HA address is valid and that the MIPv6 home network has not been renumbered before sending the BU to the HA. Should the HA address not be valid, the AAAh normally indicates the error to the MN and assigns a HA as described above, i.e. the AAAh sends a HA address, credentials (or data from which the credentials can be derived) and possibly a home address to the MN etc.

The Diameter MIPv6 Application may sometimes be used also to convey accounting data generated in the HA 36. This can be useful for instance when reverse tunneling is employed and the home operator wants to be able to verify the accounting data that is received from the AAAv 24.

Now, some exemplary implementations of a generic container attribute (GCA) in accordance with the present invention will be described more in detail.

Preferably the GCA attribute is available to all methods and can be included in any EAP message, including EAP Success/Failure messages. This implies that it should be a part of the EAP layer rather than the EAP method layer (see [18]). Hereby, an important issue to consider is backward compatibility in terms of the MN and the EAP authenticator (typically the EAP entity in the Network Access Server (NAS)). The use of the generic container attribute in the above examples assumes that the new attribute is introduced in EAP in a manner that is backward compatible and transparent to the EAP authenticator. Introducing a GCA with these properties requires some special considerations, which will be elaborated in the following paragraphs.

The format of the GCA could for example be a two-byte GCA length indicator followed by a GCA recipient indicator and a GCA payload. The GCA recipient indicator then indicates to what internal entity the EAP module is to send the payload of a received GCA (i.e. this indicator corresponds to the protocol/next header field in the IP header or the port number in the UDP and TCP headers). The GCA payload is a generic chunk of data not interpreted by the EAP layer. Absence of GCA can for example be indicated by a GCA length indicator set to zero.

To achieve backward compatibility, the GCA should be included in the EAP packets in a way that is transparent to pass-through EAP authenticators. A pass-through EAP authenticator is an EAP authenticator residing in a NAS, which relays EAP packets between the MN and a back-end EAP authentication server (an AAA server). The pass-through behavior of an EAP authenticator is to relay EAP packets based on the EAP layer header, i.e. the Code, Identifier and Length fields in the beginning of the EAP packets. This implies that the desired transparency and hence backwards compatibility can be achieved by locating the GCA after the EAP layer header, i.e. after the Code, Identifier and Length fields.

However, an EAP authenticator normally also has to check the Type field (following the EAP layer header) of EAP Response packets in order to identify EAP Identity Response packets, from which the NAI that is needed for the AAA routing is extracted. When the EAP authenticator identifies an EAP Identity Response packet, it extracts the NAI from the Type-Data field following the Type field. Hence, placing the GCA immediately after the EAP layer header (in a manner that is transparent to the EAP authenticator) is only possible in EAP Request packets. Therefore, it would normally be preferred to arrange the GCA after the Type field or even after the (possibly NULL-terminated) Type-Data field.

Placing the GCA immediately after the Type field would enable the use of the GCA in all EAP Response packets but EAP Identity Response packets. The use of the GCA in EAP Identity Response packets would be prohibited, because from these packets the EAP authenticator needs to extract the NAI from the Type-Data field, which a legacy EAP authenticator would expect to find immediately after the Type field. This can be a significant restriction for the GCA usage considering that EAP normally has rather few roundtrips. Possibly, the GCA could be placed after a NULL-terminated Type-Data field in the EAP Identity Response packet, while keeping its position after the Type field in other EAP packets.

However, it would often be desirable with a GCA position that can be used consistently in all EAP packets. It follows from the above discussion that a position in which the GCA could be placed in all EAP packets in a backwards-compatible manner is at the end of the packet, more or less as a trailer. However, this GCA location would cause problems for those EAP packets that do not have explicit length indicators for the Type-Data parameter(s), but rely on the Length field in the EAP layer header. For such packets, it would generally not be possible to distinguish between the GCA and the Type-Data field.

To overcome this problem, it is according to a particular preferred GCA embodiment proposed to reverse the order of the GCA length indicator, the GCA recipient indicator and the GCA payload such that the GCA length indicator appears last. By placing the GCA at the end of an EAP packet, the last two octets of the EAP packet (whose length is indicated by the Length field in the EAP layer header) would always be the GCA length indicator. Unless the GCA length indicator is zero, the GCA recipient indicator appears before the GCA length indicator and the GCA payload (whose size is determined from the GCA length indicator) is located before the GCA recipient indicator. In this way, it is always be possible to identify the GCA of an EAP packet and to distinguish the GCA from the Type-Data field, while the use of the GCA would still be transparent for a pass-through EAP authenticator.

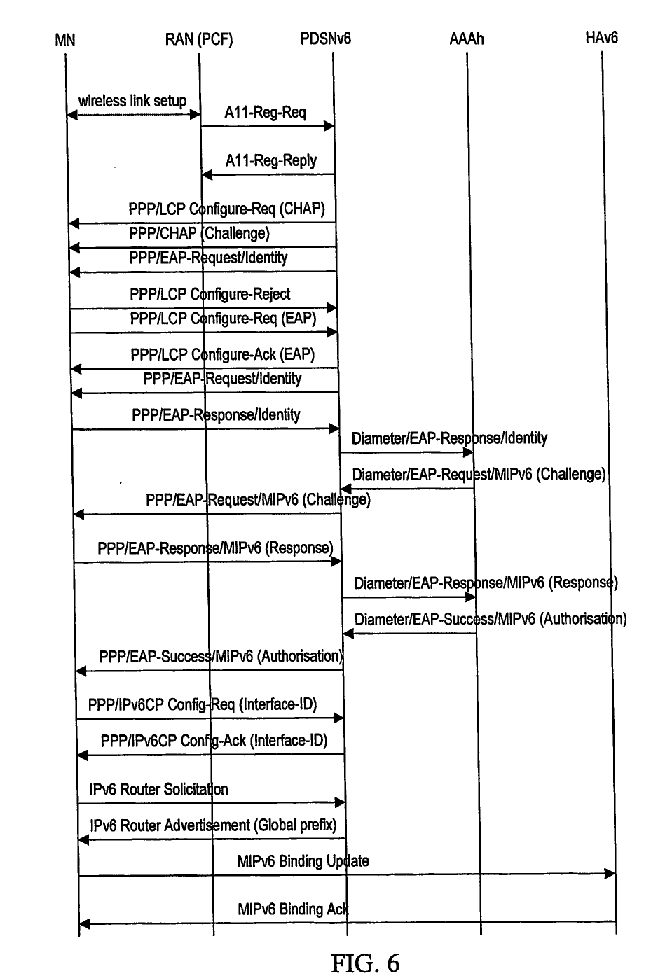

Backward compatibility with the GCA embodiment of FIG. 6 further presumes that the EAP authenticator does not try to extract information from the EAP Request/Response packets (except the EAP layer header and the NAI) and that it accepts that the Length field in the Success/Failure packets indicates a value greater than 4.

An alternative way of coping with the backwards compatibility problem is to use EAP GCA Test Request/Response packets, i.e. new EAP packets with newly defined values of the Type field, to determine whether the MN supports the GCA. Before or after the initial EAP Identity Request/Response packet exchange, an EAP authenticator supporting the GCA then sends an EAP GCA Test Request packet, i.e. an EAP Request packet with a dedicated Type value, to the MN. (The EAP peer state machine in [19] indicates that both the alternative sending times are feasible.) If the MN supports the GCA, it responds with an EAP GCA Test Response packet. Otherwise, the MN interprets the EAP GCA Test Request packet as a request to use an unknown EAP method and therefore the MN responds with an EAP Nak packet. Based on the response from the MN, the EAP authenticator determines whether the MN supports the GCA.

A MN supporting GCA can determine whether the EAP authenticator supports the GCA from the presence or absence of the EAP GCA Test Request packet. If an EAP GCA Test Request packet is received when expected i.e. before or after the EAP Identity Request/Response exchange, the EAP authenticator is assumed to support the GCA. Otherwise, the MN draws the conclusion that the EAP authenticator does not support the GCA.

If both the MN and the EAP authenticator support the GCA, it can be placed after the EAP layer header in all subsequent EAP packets (with the original order of the GCA components). Otherwise, the GCA may still be included in the EAP packets that allow it to be included in the backward-compatible manner described above.

There are some limitations to the described alternative way of dealing with the backward compatibility problem. Firstly, one MN-EAP authenticator roundtrip is wasted. Moreover, if the EAP GCA Test Request/Response packets are exchanged after the initial EAP Identity Request/Response packet exchange, the GCA cannot be used in the EAP Identity Response packet. This embodiment may also require that the EAP authenticator (e.g. the NAS) uses a modified version of EAP, such as EAPv2. Accordingly, although other alternatives are possible, the preferred way of arranging the GCA in EAP packets would typically be as a trailer at the end of the packet with the GCA length indicator last, after the GCA payload and the GCA recipient indicator.

If the number of EAP roundtrips is not enough for the data that is exchanged in the GCA, the AAAh may increase the number of EAP roundtrips through EAP Notification Request/Response exchanges for the purpose of conveying the GCA.

If the GCA is made method specific, the GCA does not introduce any problems related to backward compatibility, since it will then normally be a part of the Type-Data field.

Exemplary Implementations Specifically Tailored for CDMA Frameworks

In the following, a number of exemplary embodiments of MIPv6 implementations in accordance with the invention will be described. General reference is made to the architectures of FIGS. 1 and 2. To show the overall flow and viability of concept, reference will also be made to the exemplary signaling flow diagrams in FIGS. 5-11.

As compared to the above examples of FIGS. 3 and 4, the signaling flows of FIGS. 5-11 are more specifically tailored for CDMA frameworks, and CDMA2000 in particular. In these flow diagrams, the AAAh-HA or MN-HA interaction has for simplicity been omitted. It is assumed that some form of HA-MN key distribution takes place, e.g. as illustrated in FIGS. 3 and 4.

The term “EAP/MIPv6” is here used to denote the new extended EAP protocol that is used to transfer the MIPv6-related information over the AAA infrastructure in preferred embodiments of the invention. EAP/MIPv6 can for example use the above-described new EAP TLV attributes or generic container attribute to carry the MIPv6-related data.

The exemplary schemes for authentication and authorization support for Mobile IP version 6 (MIPv6) in a CDMA system are:
(A) MIPv6 initiation with MIPv6 authentication using PPPv6 [9] in a manner similar to the PPP usage specified in 3GPP2 Mobile IPv4 Operation
(B) MIPv6 initiation with MIPv6 authentication using PPPv6 as defined in IETF
(C) MIPv6 initiation with MIPv6 authentication using CSD-PPP
(D) MIPv6 hand-in with MIPv6 authentication using PPPv6 as specified in 3GPP2 Simple IPv6 Operation
(E) MIPv6 hand-in with MIPv6 authentication using CSD-PPP
(F) MIPv6 re-authentication using PANA
(G) MIPv6 re-authentication using PPP

MIPv6 initiation (A, B, C) is generally performed when there is no prior MIPv6 service available, and the mobile wants to receive MIPv6 service—the mobile sends the desired MIPv6 parameters to the network in the initiation request. MIPv6 hand-in (D, E) is used in cases where there is prior MIPv6 service ongoing, and a handover takes place—there is a need to reestablish the necessary bearers for MIPv6 service to be able to continue. MIPv6 re-authentication (F, G) typically occurs when the trust relationship between the mobile and the Home Agent expires and there is need to renew this to continue the MIPv6 service.

(A) MIPv6 Initiation with MIPv6 Authentication using PPPv6 in a Manner Similar to the PPP Usage Specified in 3GPP2 Mobile IPv4 Operation

The MN, RAN, and PDSN setup the necessary radio links and A10/A11 links according to the 3GPP2 standards.
The PDSN initially offers the MN the possibility to use CSD-PPP. This is carried out by sending a standard PPP/LCP packet first, followed immediately by a PPP/CHAP packet and then a PPP/EAP packet, see FIG. 12. However, the MN opts for using PPP and ignores (silently discards) messages that are not PPP/LCP.
No authentication phase is carried out within PPPv6.
No IP address is requested at NCP (IPv6CP) phase within PPPv6
Following PPP, IP packets (e.g., PANA, DHCP) are not sent until NCP (IPv6CP) phase is completed.
PANA exchanges start after IPv6CP is completed. PANA protocol is used to carry EAP between MN and PDSN. DHCP is also sent concurrently to request global IP address (with a subsequent DHCP reply).
EAP/MIPv6 is used to carry information that facilitate MIPv6 authentication, dynamic MN home address allocation, etc.
PANA protocol is used to carry EAP between MN and PDSN.
Diameter [e.g. 13] is used to carry EAP between PDSN and AAAh (other protocols like Radius are also possible).
The rest of the sequence may for instance follow the extended EAP signaling flow schemes for the MIPv6 initiation case of FIGS. 3 and 4.
DHCP [20] can be used for stateful IP address autoconfiguration. (An alternative is to use stateless IP address autoconfiguration, with router solicitation/advertise+duplicate address detection, but this will typically add at least one more RTT to the signaling flow.)
About 6.5 round trip time (RTT) is generally needed from after successful setup of A10 connection to before MIPv6 Binding Update is sent by MN to HA.

An exemplary embodiment of a scheme for MIPv6 initiation with MIPv6 authentication using PPPv6 in a manner similar to the PPP usage specified in 3GPP2 Mobile IPv4 Operation is illustrated in the signaling flow diagram of FIG. 5.

(B) MIPv6 Initiation with MIPv6 Authentication using PPPv6 as Defined in IETF

The MN, RAN, and PDSN setup the necessary radio links and A10/A11 links according to the 3GPP2 standards.
The PDSN initially offers the MN the possibility to use CSD-PPP. This is carried out by sending a standard PPP/LCP packet first, followed immediately by a PPP/CHAP packet and then a PPP/EAP packet (FIG. 12). However, the MN opts for using PPP and ignores (silently discards) messages that are not PPP/LCP.
The authentication phase within PPP is used for EAP authentication.
EAP/MIPv6 is used to carry information that facilitate MIPv6 authentication, dynamic MN home address allocation, etc.
Diameter is used to carry EAP between PDSN and AAAh (other protocols like Radius are also possible).
The extended EAP (i.e. EAP/MIPv6) signaling flow schemes may for example be as for the MIPv6 initiation case of FIGS. 3 and 4.
After the PPP authentication phase, the NCP (IPv6CP) phase within PPP is used for Interface-ID assignment.
Following PPP, IP packets (e.g., Router Solicitation) are not sent until NCP (IPv6CP) phase is completed.
IPv6 Router Solicitation is sent after the IPv6CP is completed. Router Solicitation/Advertisement is used to obtain the global prefix for IPv6 address.
About 5.5 RTT is generally needed from after successful setup of A10 connection to before MIPv6 Binding Update is sent by MN to HA.

An exemplary embodiment of a scheme for MIPv6 initiation with MIPv6 authentication using PPPv6 as defined in IETF is illustrated in the signaling flow diagram of FIG. 6.

(C) MIPv6 Initiation with MIPv6 Authentication using CSD-PPP

The MN, RAN, and PDSN setup the necessary radio links and A10/A11 links according to the 3GPP2 standards.
The PDSN initially offers the MN the possibility to use CSD-PPP. This is carried out by sending a standard PPP/LCP packet first, followed immediately by a PPP/CHAP packet and then a PPP/EAP packet (FIG. 12). The MN opts for CSD-PPP using PPP/EAP because it wants to initiate MIPv6. PPP/LCP is processed concurrently. The PPP/CHAP packet is silently discarded.
According to CSD-PPP, PPP/IPv6CP and IP packets (e.g., Router Solicitation) can be sent concurrently with PPP/EAP packets.
EAP/MIPv6 is used to carry information that facilitate MIPv6 authentication, dynamic MN home address allocation, etc.
Diameter is used to carry EAP between PDSN and AAAh (other protocols like Radius are also possible).
The extended EAP (i.e. EAP/MIPv6) signaling flow schemes may for example correspond to the MIPv6 initiation case of FIGS. 3 and 4.
The IPv6CP is used for Interface-ID assignment.
Router Solicitation/Advertisement is used to obtain the global prefix for IPv6 address.
About 2.5 RTT is generally needed from after successful setup of A10 connection to before MIPv6 Binding Update is sent by MN to HA. Gains along a factor of 3-4 RTT are obtainable with respect to the above schemes (A) and (B) where CSD-PPP is not used.

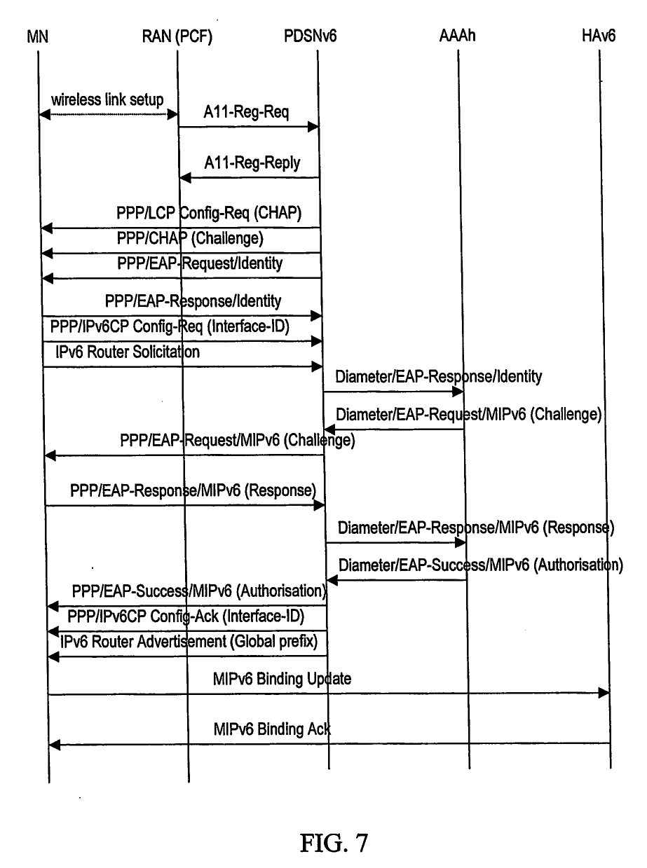

An exemplary embodiment of a scheme for MIPv6 initiation with MIPv6 authentication using CSD-PPP is illustrated in the signaling flow diagram of FIG. 7.

(D) MIPv6 Hand-in with MIPv6 Authentication using PPPv6 as Specified in 3GPP2 Simple IPv6 Operation

The MN, RAN, and PDSN setup the necessary radio links and A10/A11 links according to the 3GPP2 standards.
The PDSN initially offers the MN the possibility to use CSD-PPP. This is carried out by sending a standard PPP/LCP packet first, followed immediately by a PPP/CHAP packet and then a PPP/EAP packet (FIG. 12). However, the MN opts for using PPP and ignores (silently discards) messages that are not PPP/LCP.
There is no need to distinguish signaling flows for Simple IPv6 and MIPv6 hand-in. Simple IPv6 procedures that are currently specified in 3GPP2 [2] is reused.
The authentication phase in PPP is used for CHAP authentication.
The NCP (IPv6CP) phase within PPP is used for Interface-ID assignment.
Following PPP, IP packets (e.g., Router Solicitation) are not sent until IPv6CP phase is completed.
IPv6 Router Solicitation is sent after the IPv6CP is completed. Router Solicitation/Advertisement is used to obtain the global prefix for IPv6 address.
About 4.5 RTT is generally needed from after successful setup of A10 connection to before MIPv6 Binding Update is sent by MN to HA.

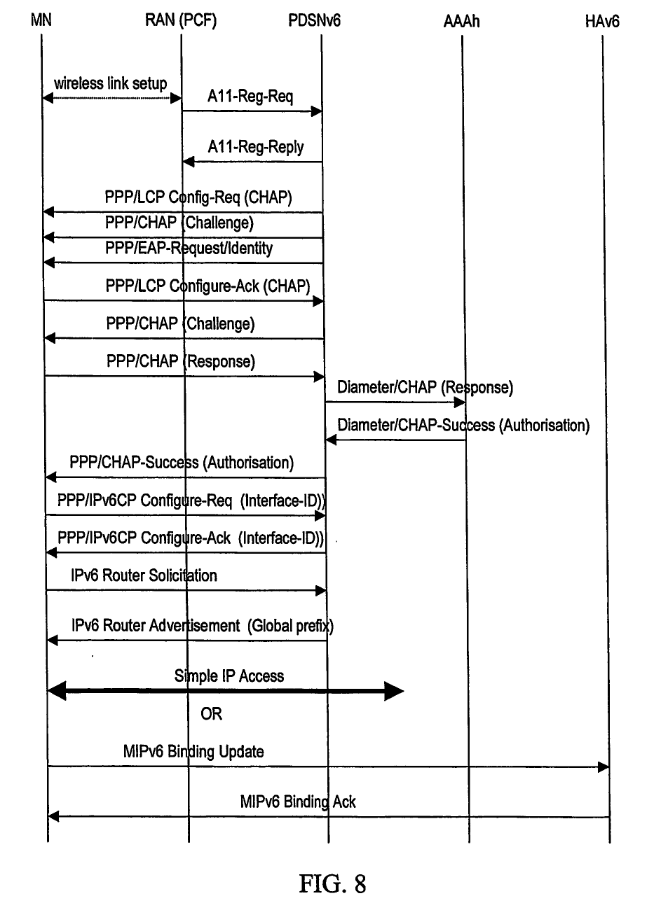

An exemplary embodiment of a scheme for MIPv6 hand-in with MIPv6 authentication using PPPv6 as specified in 3GPP2 Simple IPv6 Operation is illustrated in the signaling flow diagram of FIG. 8.

(E) MIPv6 Hand-in with MIPv6 Authentication using CSD-PPP

The MN, RAN, and PDSN setup the necessary radio links and A10/A11 links according to the 3GPP2 standards.
The PDSN initially offers the MN the possibility to use CSD-PPP. This is carried out by sending a standard PPP/LCP packet first, followed immediately by a PPP/CHAP packet and then a PPP/EAP packet (FIG. 12). The MN opts for CSD-PPP using PPP/CHAP because it wants MIPv6 Hand-in. PPP/LCP is processed concurrently. The PPP/EAP packet is silently discarded.
According to CSD-PPP, PPP/IPv6CP and IP packets (e.g., Router Solicitation) can be sent concurrently with PPP/CHAP packets.
The IPv6CP is used for Interface-ID assignment.
Router Solicitation/Advertisement is used to obtain the global prefix for IPv6 address.
About 1.5 RTT is generally needed from after successful setup of A10 connection to before MIPv6 Binding Update is sent by MN to HA. Gains along a factor of 3 RTT are obtainable with respect to scheme (D) where CSD-PPP is not used.

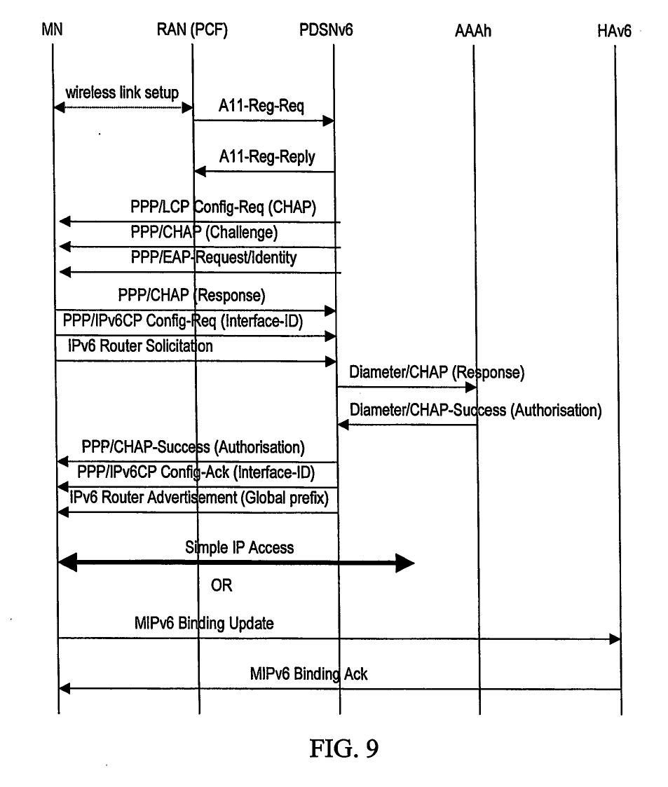

An exemplary embodiment of a procedure for MIPv6 hand-in with MIPv6 authentication using CSD-PPP is illustrated in the signaling flow diagram of FIG. 9.

(F) MIPv6 Re-authentication using PANA

The necessity for MN to initiate MIPv6 re-authentication arises due to, e.g., expiration of the HA-MN IPSec Key Lifetime.
PANA is used to carry EAP.
EAP/MIPv6 is used to carry information that facilitates MIPv6 re-authentication.
Diameter is used to carry EAP between PDSN and AAAh (other protocols like Radius are also possible).
The extended EAP (i.e. EAP/MIPv6) signaling flow schemes may for example correspond to the MIPv6 initiation case of FIGS. 3 and 4.
About 4 RTT is generally needed from PANA initiation to before MIPv6 Binding Update is sent by MN to HA.

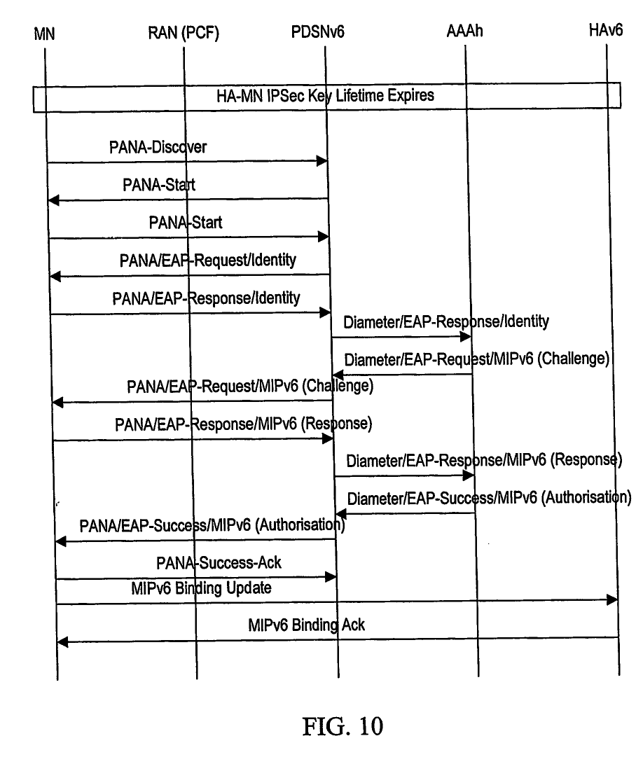

An exemplary embodiment of a scheme for MIPv6 re-authentication using PANA is illustrated in the signaling flow diagram of FIG. 10.

(G) MIPv6 Re-authentication using PPP

The necessity for MN to initiate MIPv6 re-authentication arises due to, e.g., expiration of the HA-MN IPSec Key Lifetime.
The authentication phase of PPP is used for EAP authentication.
EAP/MIPv6 is used to carry information that facilitates MIPv6 re-authentication.
Diameter is used to carry EAP between PDSN and AAAh (other protocols like Radius are also possible).
The extended EAP (i.e. EAP/MIPv6) signaling flow schemes may for example correspond to the MIPv6 initiation case of FIGS. 3 and 4.
About 3 RTT is generally needed from PPP/LCP Configure-Req to before MIPv6 Binding Update is sent by MN to HA.

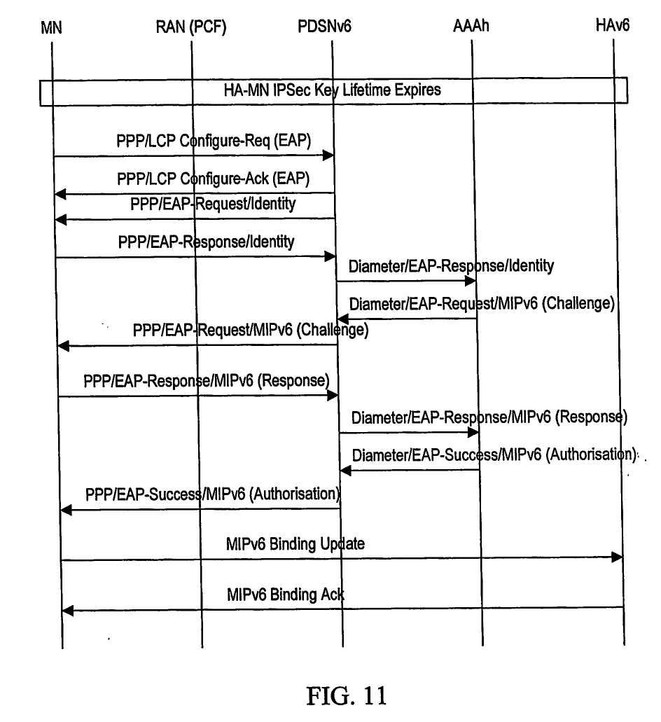

An exemplary embodiment of a scheme for MIPv6 re-authentication using PPP is illustrated in the signaling flow diagram of FIG. 11.

From the above description follows that preferred embodiments of the method for MIPv6 authentication in accordance with the invention use an extended authentication protocol like extended EAP for MIPv6 initiation (A, B, C) and MIPv6 re-authentication (F, G). For MIPv6 hand-in (D, E), CHAP can with advantage be used, and router solicitation/advertisement for obtaining the global prefix for IPv6 addresses.

As illustrated by the above authentication schemes, the invention is not limited to particular protocols. Scheme F (FIG. 10), for example, illustrates that PANA in some respects constitutes an alternative to PPP of scheme G (FIG. 11). Authentication procedures using protocols and protocol combinations with functionality corresponding to the illustrated examples also lie within the scope of the invention.

It should be noted that all combinations of the respective schemes for MIPv6 initiation, MIPv6 hand-in and MIPv6 re-authentication are possible. Which particular schemes that are to be chosen in a particular implementation should normally be decided based on a number of factors, of which the setup time may be one.

It should be mentioned that the present invention also can be used in connection with a so-called “local Home Agent” in the visited network. The local HA can be used for example when there is no HA 36 in the home network. Instead a local HA is dynamically assigned to a roaming MN in the visited domain. The MIPv6 AAA signaling can then follow the path MN [symbol] RN [symbol] PDSN [symbol] AAAv [symbol] AAAh [symbol] AAAv [symbol] local HA. It is for example possible to use an extended Diameter application between the AAAh and the AAAv as well as between the AAAv and the local HA. Such a solution would generally require MIPv6 support in the AAAv.

Accordingly, a major advantage offered by the present invention is that it enables MIPv6 authentication and authorization in frameworks like CDMA2000. A complete MIPv6 AAA solution for CDMA systems is achieved by means of an extended authentication protocol that operates end-to-end in a manner transparent to the visited domain, including e.g. the access network, the PDSN and the AAA server in the visited network. This makes it possible to let some or all of these nodes act as mere pass-through agents, which is a considerable advantage. It will also be possible to apply prior encryption between MN and AAAh since the exchanges are not visible over the air interface. This means that satisfactory security against eavesdropping, man-in-the-middle and other attacks can be maintained for mobile nodes roaming in foreign CDMA networks. In addition, it makes it possible for an operator to deploy the solution without relying on upgrades in its roaming partners'0 networks.

Another benefit is that shorter packet data session setup times can be achieved by means of the invention. By allowing different procedures for the MIPv6 hand-in case and the MIPv6 initiation case, respectively, such as EAP/MIPv6 for initiation and CHAP for hand-in, it is possible to shorten packet data session setup times for the MIPv6 hand-in case compared with the MIPv6 initiation case. In this way, at least 1 RTT can be saved by allowing different procedures for the two cases. Moreover, using CSD-PPP considerably shortens the packet data session setup time compared with PPP. Gains along a factor of 3-4 RTT are obtainable.

The session setup time can, where appropriate, also be shortened by using PPP instead of e.g. PANA, since procedures involving PANA generally take up more RTT to complete compared with procedures where only PPP is used. However, even though PPP may be superior with regard to session setup times, it may still be appropriate to use procedures involving PANA, for instance in case a layer-3-only solution is preferred.

Another advantageous feature of the invention is that the need for distinguishing between signaling flows for Simple IPv6 and MIPv6 hand-in, for example, can be eliminated. Both can use common authentication procedures. Simple IPv6 procedures that are currently specified in 3GPP2 can be reused.

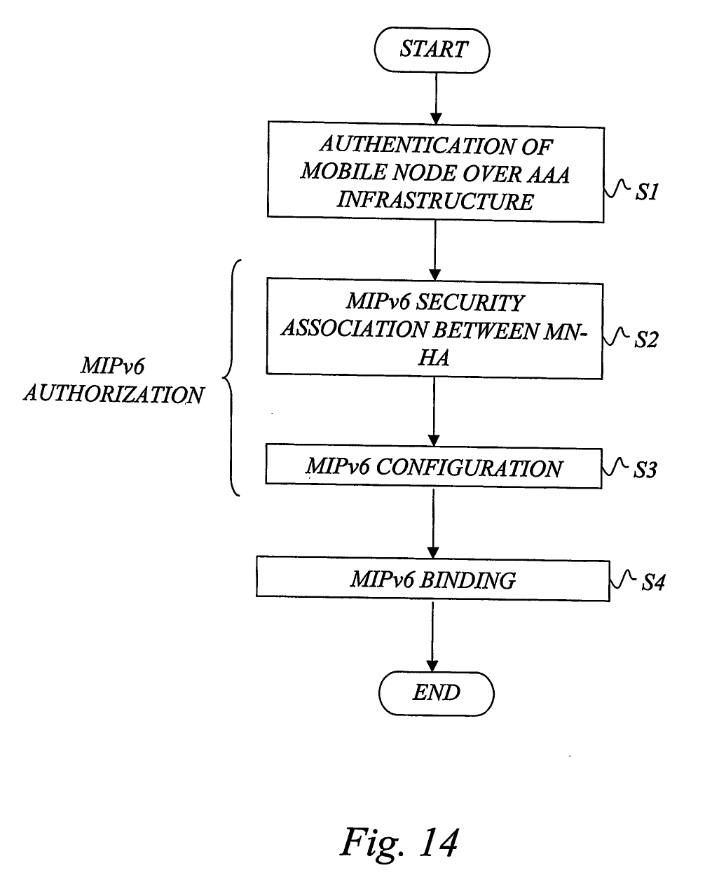

Summarizing some of the above aspects, it can be seen that FIG. 14 is a schematic flow diagram of a basic example of a method for supporting MIPv6 service for a mobile node in a CDMA system. In this example, the information transfer and actions indicated in steps S1-S4 relate to authentication of the mobile node (S1), establishment of MN-HA security association (S2), MIPv6 configuration (S3) and MIPv6 binding (S4). The steps S2-S3 are commonly referred to as the authorization phase. The steps S1-S4 may, if desired, be executed more or less in parallel to allow shortening of the overall setup times. In step S1, information is transferred over the AAA infrastructure for authenticating the mobile node at the home network side. In step S2, MIPv6-related information is transferred to immediately establish, or to enable future establishment of, a security association between the MN and HA. In step S3, additional MIPv6 configuration is performed, for example by transferring configuration parameters to the mobile node and/or home agent for suitable storage therein. In step S4, the mobile node sends a binding update and a MIPv6 binding is established in the HA.

Detailed exemplary embodiments of the present invention have primarily been discussed with reference to the current EAP [7, 18]. However, it should be understood that the invention very well is applicable onto other EAP versions, such as EAPv2, as well as other authentication protocols extended in the described manner. EAP is merely an example of a possible implementation, and the invention is generally not limited thereto and may alternatively involve non-EAP schemes.

In the above illustrative examples, it has been assumed that the mobile node (MN) and the AAAh have a common shared secret. This could for example be a symmetric key shared between the identity module installed in the mobile node and the home network. The identity module can be any tamper-resistant identity module known to the art, including standard SIM cards used in GSM mobile telephones, Universal SIM (USIM), WAP SIM, also known as WIM, ISIM and, more generally, UICC modules. For the MN-HA security relation, a seed or nonce can be conveyed by the MN to the AAAh (or the other way around, i.e. the seed is originated by the AAAh and conveyed to the MN) from which the AAAh can create the MN-HA security key(s), e.g. a pre-shared key, based on the shared secret. The mobile node is able to generate the same security key(s) by itself since it originated the seed/nonce (or receives the seed from the AAAh) and also has the shared secret. Alternatively the AAAh may solely generate the MN-HA security key(s) and transfer them to the MN (cryptographically protected) and the HA.

Although the invention has been described with reference to specific exemplary embodiments, it also covers equivalents to the described features, as well as modifications and variants obvious to a man skilled in the art.

### REFERENCES

[1] Mobility Support in IPv6, D. Johnson, C. Perkins, J. Arkko, May 26, 2003.
[2] 3GPP2 X.P0011 Ver.1.0-9, 3GPP2 Wireless IP Network Standard, February, 2003.
[3] Diameter Mobile IPv6 Application, Stefano M. Faccin, Franck Le, Basavaraj Patil, Charles E. Perkins, April 2003.
[4] Protocol for Carrying Authentication for Network Access (PANA), D. Forsberg, Y. Ohba, B. Patil, H. Tschofenig, A. Yegin, April 2003.
[5] IPv6style—Address Autoconfiguration in IPv6, HEO SeonMeyong Internet Research Institute, Jan. 27, 2003.
[6] IEEE Standard 802.1X, Local and metropolitan area networks—Port-Based Network Access Control
[7] PPP Extensible Authentication Protocol (EAP), RFC2284, L. Blunk, J. Vollbrecht, March 1998.
[8] The Point-to-Point Protocol (PPP), RFC1661, W. Simpson, July 1994.
[9] IP Version 6 over PPP, RFC2472, D. Haskin, E. Allen, December 1998.
[10] U.S. Pat. No. 6,487,218, Method and Device for Configuring A Link, R. Ludwig, M. Gerdes, Nov. 26, 2002.
[11] Internet Security Association and Key Management Protocol (ISAKMP), RFC2408, D. Maughan, M. Schertler, M. Schneider, J. Turner, November 1998
[12] Diameter Mobile IPv4 Application, P. Calhoun, T. Johansson, C. Perkins, Apr. 29, 2003
[13] Diameter Extensible Authentication Protocol (EAP) Application, T. Hiller, G. Zorn, March 2003.
[14] Remote Authentication Dial In User Service (RADIUS), RFC2865, C. Rigney, S. Willens, A. Rubens, W. Simpson, June 2000
[15] RADIUS Extensions, RFC2869, C. Rigney, W. Willats, P. Calhoun, June 2000
[16] EAP AKA Authentication, J. Arkko, H. Haverinen, October 2003.
[17] EAP SIM Authentication, H. Haverinen, J. Salowey, October 2003.
[18] Extensible Authentication Protocol (EAP), L. Blunk, J. Vollbrecht, B. Aboba, J. Carlson, H. Levkowetz, September 2003
[19] State Machines for EAP Peer and Authenticator, J. Vollbrecht, P. Eronen, N. Petroni, Y. Ohba, October 2003
[20] Dynamic Host Configuration Protocol for IPv6 (DHCPv6), R. Droms, J. Bound, B. Voltz, T. Lemon, C. Perkins, M. Carney, Nov. 2, 2002.

### ABBREVIATIONS

AAA Authentication, Authorization and Accounting
AAAh Home AAA server
AAAv Visited AAA server
AKA Authentication and Key Agreement
AP Access Point
BA Binding Acknowledgement
BU Binding Update
CDMA Code Division Multiple Access
CHAP Challenge Handshake Authentication Protocol
CoA Care-of Address
CSD-PPP Circuit Switched Data Point-to-Point Protocol
DAD Duplicate Address Detection
DHCP Dynamic Host Configuration Protocol
EAP Extensible Authentication Protocol
GCA Generic Container Attribute
GSM Global System for Mobile communications
HA Home Agent
IKE Internet Key Exchange
IP Internet Protocol
IPCP IP Control Protocol
IPsec IP Security
IPv6CP IPv6 Control Protocol
ISAKMP Internet Security Association and Key Management Protocol
LCP Link Control Protocol
MDMessage Digest 5
MIPv6 Mobile IP version 6
MN Mobile Node
NAI Network Access Identifier
NAS Network Access Server
NCP Network Control Protocol
PAA PANA Authentication Agent
PAC PANA Client
PANA Protocol for carrying Authentication for Network Access
PDA Personal Digital Assistant
PDSN Packet Data Serving Node
PPP Point-to-Point Protocol
PPPv6 Point-to-Point Protocol version 6
RADIUS Remote Authentication Dial User Service
RAN Radio Access Network
RN Radio Network
RTT Round Trip Time
3GPP2 Third Generation Partnership Project 2
SPI Security Parameter Index
TLV Type Length Value
WLAN Wireless Local Area Network

1. A method of authentication and authorization support for Mobile IP version 6 (MIPv6) in a CDMA system, the method comprising transferring, between a mobile node in a visited network and a home network of the mobile node, MIPv6-related authentication and authorization information in an authentication protocol in an end-to-end procedure transparent to the visited network over an AAA infrastructure.

2. (canceled)

3. The method of claim 1, wherein the end-to-end procedure is executed between the mobile node and an AAA server in the home network, and nodes in the visited network act as mere pass-through agents in the end-to-end procedure.

4. The method of claim 3, wherein the MIPv6-related information is transferred in the authentication protocol between the mobile node and the AAA home network server via an internetworking access server located in the visited network.

5. (canceled)

6. The method of claim 4, wherein point-to-point communication between the mobile node and the internetworking access server is configured based on the CSD-PPP protocol.

7. (canceled)

8. The method of claim 2, wherein the authentication protocol is an extended Extensible Authentication Protocol (EAP) and the MIPv6-related authentication and authorization information is incorporated as additional data in the EAP protocol stack.

9. (canceled)

10. The method of claim 8, wherein the MIPv6-related information is transferred in a generic container attribute available for any EAP method.

11. The method of claim 8, wherein the MIPv6-related information is transferred in a method-specific generic container attribute of the method layer in the EAP protocol stack.

12-14. (canceled)

15. The method of claim 1, wherein said method further comprises the step of performing, for the purpose of MIPv6 hand-in, CHAP authentication between the mobile node and the home network.

16-17. (canceled)

18. The method of claim 1, wherein the MIPv6-related information is transferred over the AAA infrastructure for allocation of a home agent, for establishing a MIPv6 security association between the mobile node and the home agent and for establishing a binding for the mobile node in the home agent.

19. (canceled)

20. The method of claim 4, wherein the internetworking access server offers the mobile node the possibility to use PPP or CSD-PPP by sending out a standard PPP/LCP packet and at least a PPP/EAP packet.

21-22. (canceled)

23. The method of claim 20, wherein the internetworking access server also sends out a PPP/CHAP packet together with the PPP/LCP and PPP/EAP packets.

24-26. (canceled)

27. A system for authentication and authorization support for Mobile IP version 6 (MIPv6) in a CDMA system, comprising means for transferring between a mobile node in a visited network and a home network of the mobile node, MIPv6-related authentication and authorization information in an authentication protocol in an end-to-end procedure transparent to the visited network over an AAA infrastructure.

28. (canceled)

29. The system of claim 27, wherein the end-to-end procedure is between the mobile node and an AAA server in the home network, and nodes in the visited network act as mere pass-through agents in the end-to-end procedure.

30. The system of claim 29, wherein the MIPv6-related information is transferred in the authentication protocol between the mobile node and the AAA home network server via an internetworking access server located in the visited network.

31. (canceled)

32. The system of claim 30, further comprising means for configuring point-to-point communication between the mobile node and the internetworking access server based on the CSD-PPP protocol.

33. (canceled)

34. The system of claim 27, wherein the authentication protocol is an extended Extensible Authentication protocol (EAP) and the MIPv6-related authentication and authorization information is incorporated as additional data in the EAP protocol stack.

35. (canceled)

36. The system of claim 34, wherein said means for transferring MIPv6-related information comprises means for transferring the MIPv6-related information in a generic container attribute available for any EAP method.

37 The system of claim 34, wherein said means for transferring MIPv6-related information comprises means for transferring the MIPv6-related information in a method-specific generic container attribute of the method layer in the EAP protocol stack.

38-40. (canceled)

41. The system of claim 27, wherein said system further comprises means for performing, for the purpose of MIPv6 hand-in, CHAP authentication between the mobile node and the home network.

42. (canceled)

43. The system of claim 27, wherein said means for transferring MIPv6-related information is operable for transferring the MIPv6-related information over the AAA infrastructure for allocation of a home agent, for establishing a MIPv6 security association between the mobile node and the home agent, and for establishing a binding for the mobile node in the home agent.

44-45. (canceled)

46. The system of claim 30, wherein the internetworking access server (22) is operable for offering the mobile node the possibility to use PPP or CSD-PPP by sending out a standard PPP/LCP packet and at least a PPP/EAP packet.

47-48. (canceled)

49. The system of claim 46, wherein the internetworking access server is operable for sending out a PPP/CHAP packet together with the PPP/LCP and PPP/EAP packets.

50-52. (canceled)

53. A system for Mobile IP version 6 (MIPv6) hand-in within a CDMA framework, characterized by means for performing CHAP authentication between a mobile node in a visited network and an AAA server in a home network of the mobile node over an AAA infrastructure.

54-57. (canceled)
